(19) United States
(12) Patent Application Publication
(10) Pub. No.: US 2006/0065881 A1
(43) Pub. Date: Mar. 30, 2006

(54) GDL

(76) Inventors: Bishop Walton, Turlock, CA (US); Dorothy Walton, Turlock, CA (US)

Correspondence Address: Raymond M. Galasso;Galasso & Associates LP, P.O. Box 26503, Austin, TX, 78755-0503, US

(21) Appl. No.: 11/235,010

(22) Filed: Sep. 26, 2005

Related U.S. Application Data
(60) Provisional application No. 60/613,258, filed on Sep. 27, 2004.

(51) Int. Cl. B66F 3/24

(52) U.S. Cl. 254/93 H

(57) ABSTRACT

GDL is a device that can be used for installing or removing a garbage disposal unit while allowing the user to keep his hands free. GDL is comprised of a jack, jack handle, base, and platform. A user utilizes this device by securing a garbage disposal unit on the platform and jacking the garbage disposal unit into or out of position under the mounting assembly. The user can then use two free hands to maneuver the garbage disposal unit.

### CROSS REFERENCE TO RELATED APPLICATIONS

This Non-Provisional Patent Application claims priority to U.S. Provisional Application No. 60/613,258 filed on Sep. 27, 2004 entitled GDL.

### FIELD OF THE DISCLOSURE

The disclosures made herein relate generally to hand tools. The invention discussed herein is in the general classification of a production-support mechanism for waste disposal units.

### BACKGROUND

Typically, the installation of garbage disposal units is a time consuming and difficult process. An installer must hold and balance the garbage disposal unit with one hand while using the other hand to lock and secure it into position. Because positioning the garbage disposal unit to the mounting assembly is most easily done with two hands, there is a need in the art for a device that can hold the garbage disposal unit in place while an installer positions the garbage disposal unit under a mounting assembly.

### SUMMARY OF THE DISCLOSURE

In general, GDL allows a person to utilize a jack system with a base and a platform to position a garbage disposal unit into place. This device allows the user to have both hands free for mounting the garbage disposal unit or for other tasks necessary when installing a garbage disposal.

In one embodiment of GDL, the device consists of a jack, jack handle, base, platform and rod. The device may also include cross bars and screws.

The principal object of this invention is to provide a device that can be used for installing or removing a garbage disposal unit while allowing the user to keep his hands free.

Another object of the invention is to provide a relatively inexpensive and easy to use device for installing a garbage disposal unit.

### BRIEF DESCRIPTION OF THE DRAWINGS

FIG. 1 depicts a perspective view of the preferred embodiment of GDL.

FIG. 2 depicts a side view of the preferred embodiment of GDL.

### DETAILED DESCRIPTION OF THE DRAWINGS

GDL is comprised of at least some of the following: jack, jack handle, base, platform and rod.

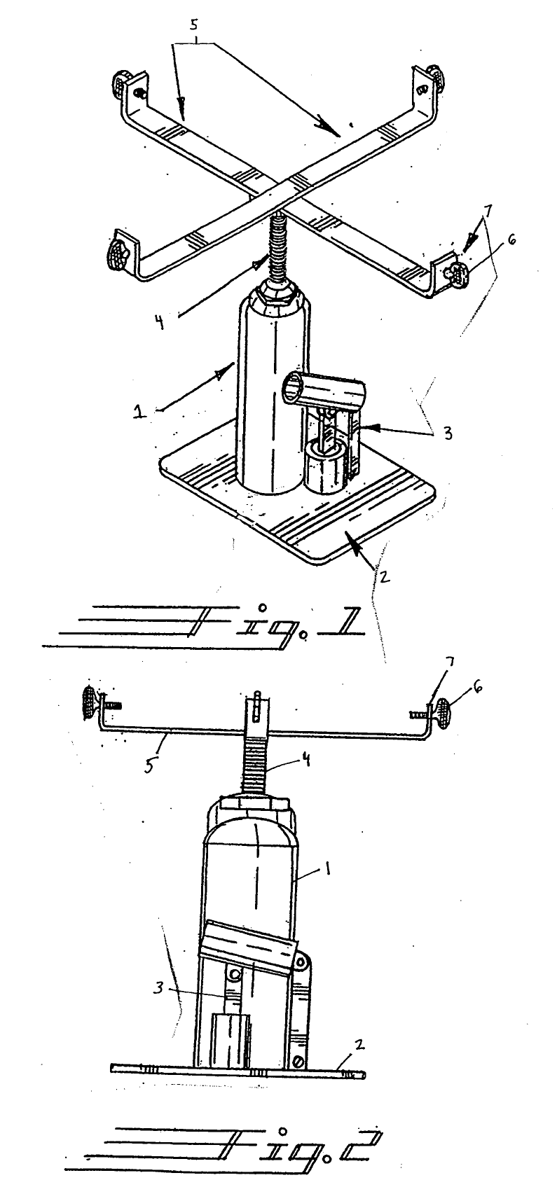

In the preferred embodiment of the invention, shown in FIG. 1, a jack 1 is attached to a roughly square base 2. The jack 1 is operated through the use of a jack handle 3. In this embodiment, the jack 1 is a hydraulic cylinder and the jack handle 3 is a hydraulic pump.

When the jack handle 3 is pumped, a threaded rod 4 rises out of the jack 1 to allow a cross bar platform 5 attached to the rod 4 to be oriented directly underneath a mounting assembly. The cross bar platform 5 has a set of flathead screws 6 at the raised ends 7 to allow a user to securely fasten the garbage disposal unit during installation or removal.

The sides of the roughly square base 2 are approximately seven inches in length. The height of the threaded rod 4 can be adjusted from approximately six and one-half inches to about twelve and one-half inches through the use of the jack handle 3.

FIG. 2 shows the side view of the preferred embodiment of the invention. The jack 1, roughly square base 2, jack handle 3, threaded rod 4, cross bar platform 5, flathead screws 6 and raised ends 7 of the cross bar platform 5 can also all be seen in this view.

To use this device, it is placed beneath the garbage disposal unit on which work is to be performed. If installation is ongoing, the garbage disposal unit being installed can be secured within the flathead screws of the cross bar platform and jacked into position under the mounting assembly. The user can then use two hands to lock and secure the garbage disposal unit in place.

If a user is removing a garbage disposal unit, he can simply jack the cross bar platform into position under the unit being removed and then secure the unit to the cross bar platform using the flathead screws. This allows the user to then use both of his hands to disconnect the garbage disposal unit.

GDL can be offered in a variety of sizes and colors. Many of the components of the GDL will be made of metal. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

It should be obvious that the invention disclosed herein could be used for any appropriately sized home improvement project in which a user wanted to keep his hands free for other tasks. It should also be obvious that any style jack system with any appropriately sized platform and base could be utilized.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A home improvement device comprising:
(a) a jack operatively attached to a jack handle;
(b) a base to support the jack;
(c) a rod that can be raised and lowered from the jack through operation of the jack handle; and
(d) a platform attached to the top of the rod.

2. The home improvement device of claim 1 wherein the platform is a set of cross bars.

3. The home improvement device of claim 2 wherein the set of cross bars have raised ends.

4. The home improvement device of claim 3 wherein a set of screws protrude through the raised ends of the cross bars.

5. The home improvement device of claim 4 wherein the set of screws are flathead screws.

6. The home improvement device of claim 1 wherein the base is roughly square in shape.

7. The home improvement device of claim 1 wherein the base is made of steel.

8. The home improvement device of claim 1 wherein the rod is threaded.

9. The home improvement device wherein the jack is hydraulic.

10. A home improvement device comprising:
(a) a jack operatively attached to a jack handle;
(b) a base to support the jack; and
(c) a platform attached to the top of the jack.

11. A home improvement device comprising:
(a) a hydraulic jack operatively attached to a jack handle;
(b) a base that is approximately square and made of steel used to support the hydraulic jack;
(c) a threaded rod that can be raised and lowered from the hydraulic jack through operation of the jack handle; and
(d) a platform attached to the top of the threaded rod that is formed from a set of crossbars with raised ends that have a set of flathead screws protruding through the raised ends.
